(19) United States
(12) Patent Application Publication
(10) Pub. No.: US 2011/0038698 A1
(43) Pub. Date: Feb. 17, 2011

(54) Motor driven ladder rack system

(76) Inventor: Zhengxin Li, St. Louis, MO (US)

Correspondence Address: Zhengxin Li, 13312 Hobnail Dr., St. Louis, MO, 63146-4318, US

(21) Appl. No.: 12/583,175

(22) Filed: Aug. 17, 2009

(51) Int. Cl. B60P 1/32; B60P 1/34

(52) U.S. Cl. 414/479

(57) ABSTRACT

In order to save physical power and avoid using manual operative mechanism for unload/reload ladders from/onto a vehicle roof, a electric motor driven ladder rack system has been designed which includes: a fixed guide which is mounted on a vehicle roof; a pivotal guide that is pivotally coupled to the fixed guide; a driving box and a sliding ladder rack which is linked to the driving box by chain and engaged with the pivotal guide. Under acting force of motor and gravity the ladder rack moves sliding backward and pivoting downward from the horizontal position on the vehicle roof to a generally vertical position behind the vehicle at which the ladders can be unloaded/loaded. In an opposite process the ladder rack is pulled back on the vehicle roof. In these processes there is no physical power needed at all.

### CROSS-REFERENCE TO RELATED APPLICATIONS

U.S. Patent Documents

| | | | |
|---|---|---|---|
| 6,764,268 B2 | July 2004 | Levi | 414/462 |
| 7,097,409 B2 | August 2006 | Richter | 414/462 |

### TECHNICAL FIELD

The present invention relates to device for loading and unloading ladders onto/from ladder rack mounted on vehicles. More particularly, the present invention is directed to ladder rack that is driven by motor and can be moved between storage and loading/unloading position automatically. There is no physical power needed at all.

### BACKGROUND OF THE INVENTION

Many kinds of work require ladders and other large pieces of equipment, and many tools and materials are needed for work, so the big trucks are used more and more. Loading and unloading ladders and other equipments to and form the roof-mounted rack of a vehicle is a difficult and dangerous process.

Some of ladder racks have been designed to solve these problems. But such ladder racks still apply manually operative mechanism so these ladder racks can't bear more ladders or other equipments and operative altitude is not exceed the height that can be reached by hands of a people who operates the ladder rack standing on the ground. Considering the elevation of the truck, these ladder racks are difficult to be used on a truck.

A need exists for a ladder rack that can bear more ladders and other equipments, can be used on tall truck and no physical power needed to operate.

### BRIEF SUMMARY OF THE INVENTION

The present invention provides a motor driven ladder rack which has two stable positions. One is the horizontal position on vehicle's roof as well as stowage position at which the ladder can be stowed. Another one is the generally vertical position behind the vehicle as well as a loading/uploading position at which the ladder can be loaded onto the rack or unloaded from the rack. The ladder rack including:

a fixed guide assembly as well as a frame assembly which is mounted on the roof of vehicle;

a pivotal guide assembly that is pivotally coupled to the fixed guide assembly;

a driving box which is mounted underneath the pivotal guide assembly. The driving box including: a box body; motor; worm; worm gear; driving gear; two guide gears and a chain.

a sliding ladder rack which is engaged with the pivotal guide and can slide on the fixed guide and the pivotal guide. Two ends of the chain are fixed to the center of front end and rear end of the ladder rack assembly, and chain is engaged with the driving gear via the guide gears in the driving box.

According to the present invention, the processes of unloading/loading a ladder from/onto the top of a vehicle as follow: In the stowage position, ladder rack; pivotal guide and fixed guide are all in horizontal on top of the vehicle. Motor drives the chain to drag the ladder rack sliding backward on the fixed guide and the pivotal guide. When the center of gravity of the system consisting of ladders; ladder rack; pivotal guide moves back to exceed the position of pivot pin, under the acting force of gravity the system will deviate from the horizontal position and pivots downward to the ground and arrives generally vertical position at which the ladders can be unloaded from the ladder rack.

Reloading is an optical process, motor drives the chain to pull up the ladder rack. When the center of gravity of the system consisting of ladders; ladder rack; pivotal guide moves up to exceed the position of pivot pin, under the acting force of gravity the system will deviate from the generally vertical position and pivots downward to the roof of the vehicle and arrives the horizontal position at which the ladders can be stored.

The processes of unload or reload are automatically. In present invention, the width of ladder rack is as wide as the vehicle so many ladders and other equipments can be loaded on it and it is driven by a motor so the ladder rack can reach the elevation of a truck's roof. The process of loading ladders onto or unloading ladders from the roof of a truck is no physical power needed.

### DESCRIPTION OF THE DRAWINGS

FIGS. 1A through 1G are side views of a truck illustrate a sequence in moving the ladder rack of present invention from horizontal position on vehicle's roof to generally vertical position behind the vehicle and an opposite process moving the ladder rack back on top of the vehicle to horizontal position.

1A ladder rack of present invention is on top of the vehicle in a horizontal position that is the stowage position.

1B the ladder rack is dragged by motor sliding backward.

1C under the acting force of gravity the ladder rack pivots with the pivotal guide together downward to the generally vertical position.

1D the ladder rack is in the generally vertical position behind the vehicle that is loading/unloading position.

1E in an opposite process the ladder rack pulled by a motor sliding upward.

1F under the acting force of gravity the ladder rack pivots with the pivotal guide together downward to the horizontal position on top of the vehicle.

1G the ladder rack is in the horizontal position on the top of the vehicle.

FIG. 2 is a rear perspective view of a truck on which the ladder rack system according to one embodiment of the present invention is installed with a 12-foot extension ladder, an 8-foot fold ladder and a wheelbarrow mounted thereon and located in generally vertical position behind the truck.

FIG. 3 is a partly section perspective view of the pivotal guide assembly and the front end of the sliding ladder rack assembly with the ladder rack located in generally vertical position.

FIG. 4 is a section perspective view of the driving box shown the chain is engaged with the driving gear via the guide gears.

### DESCRIPTION OF THE PREFERRED EMBODIMENT

The present invention provides a ladder rack for loading, unloading and stowage of ladders and other equipments on the rack without manual operation. The ladder rack preferably has a pivotal guide which can move the ladder rack between a horizontal stowage position above a vehicle and a generally vertical loading/unloading position behind a vehicle. The pivotal guide is pivotally coupled to the fixed guide assembly via two pivot pins. The fixed guide assembly acts as a frame assembly and is attached to atop the vehicle roof securely. The ladder rack is sliding engaged to the pivotal guide which allows the ladder rack to slide forward or backward on it and to pivot together with it downward from horizontal position to generally vertical position or from generally vertical position to horizontal position. The movement of ladder rack is driven by motor and the force of gravity.

Although the ladder rack according to the present invention is described here below in reference to a specific use in conjunction with a truck, it is to be understood that this description is presented as a non-limiting example only.

As shown in FIG. 2, there is indicated generally by numeral 1 ladder rack system constructed in accordance with the present invention. It includes a fixed guide assembly 2 that is a frame assembly as well; a pivotal guide assembly 3; a driving box 4 and a sliding ladder rack assembly 5. The fixed guide assembly 2 is a U-ship frame made with L-ship cross-section metal beam; it provides a support and mounting structure for the pivotal guide assembly 3 and sliding ladder rack assembly 5, so it is a frame assembly as well. There is a pair front supporter 6 in the front end of the fixed guide 2 and a pair rear supporter 7 in the rear end. Via these supporters 6,7, the fixed guide is mounted to the roof of the truck 15. The rear supporters 7 of the fixed guide 2 provide two pivot pins 8. The two longitudinal axes of the pivot pins 8 are in the same straight line which is parallel with the roof of the vehicle and vertical with the fixed guide 2. The pivotal guide assembly 3 is pivotally coupled to the supports 7 of the fixed guide assembly 2 by the pivot pins 8 about which the pivotal guide 3 can pivot freely. The pivotal movement of the pivotal guide assembly downward to ground is limited by rear ages 9 of the rear supporters 7 of the fixed guide assembly 2, they stop the pivotal guide assembly 3 at the generally vertical position (70 degrees). The ladder rack 5 is a rectangle metal frame, in left and right side it is made of two C-shape cross-section bars which are fixed by two L-shape cross-section bars in front end and rear end. Between the two C-shape cross-section bars of the ladder rack there are some rungs on which the ladders and other equipments are mounted as shown in FIG. 2. In each side of the front end of the ladder rack 5 a guide wheel 12 is provided they can roll on the fixed guide 2. In the centre of the front end of the sliding ladder rack 5 a wedge is provided. When the ladder rack slide forward in the horizontal position, the wedge 13 is finally received in the wedge holder 14 which is in the central of the front end of the fixed guide 2 and the ladder rack 5 stops. The wedge holder 14 limits the movement of the front end of the ladder rack 5, so the ladder rack wouldn't vibrate violently when the vehicle dumped along the rough road.

FIG. 3 is partly section perspective view of the pivotal guide assembly and the front end of the sliding ladder rack assembly according to one embodiment of the present invention with the ladder rack located in generally vertical position. The pivotal guide assembly includes: the pivotal guide 3; the T-shape pivotal arm 10; the pivot pin 8; the cross beam 19 and the guide wheel 27. The pivotal guide 3 comprises two metal bars which are bolted to the T-ship pivotal arms 10. The two pieces cross beam 19 are fixed underneath the two pivotal arms 10 which are pivotally coupled to the rear supporters 7 of the fixed guide assembly 2 via the two pivot pins 8. Each side of the pivotal guide 3 provides two guide wheels 27, the C-shape cross-section bar of the sliding ladder rack 5 can slide thereon as shown in FIG. 3. The pivotal arm 10 makes the manufacture of the pivotal guide 3 easier and saves materials.

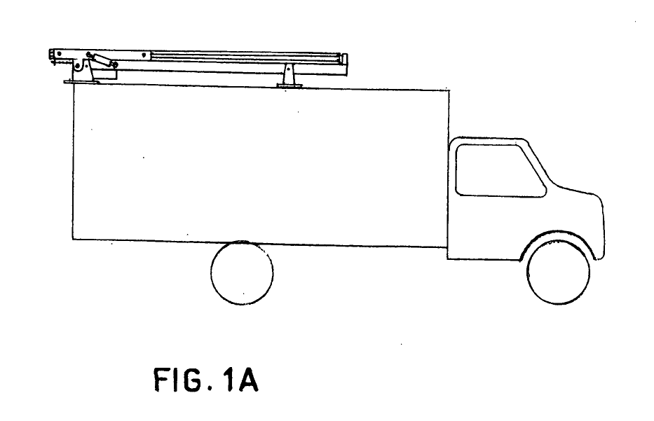

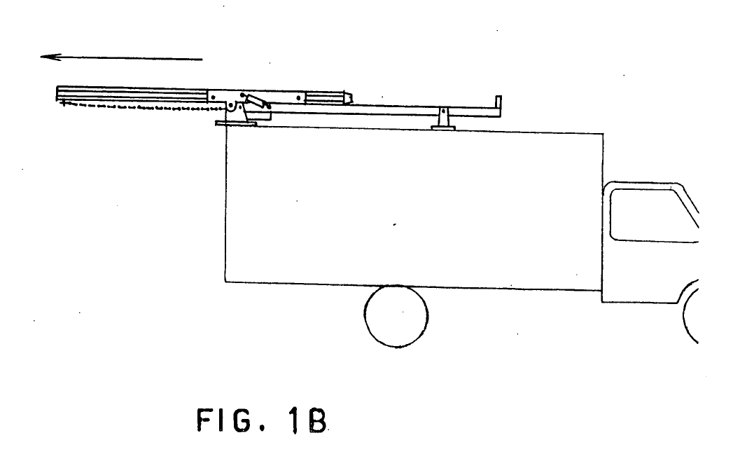

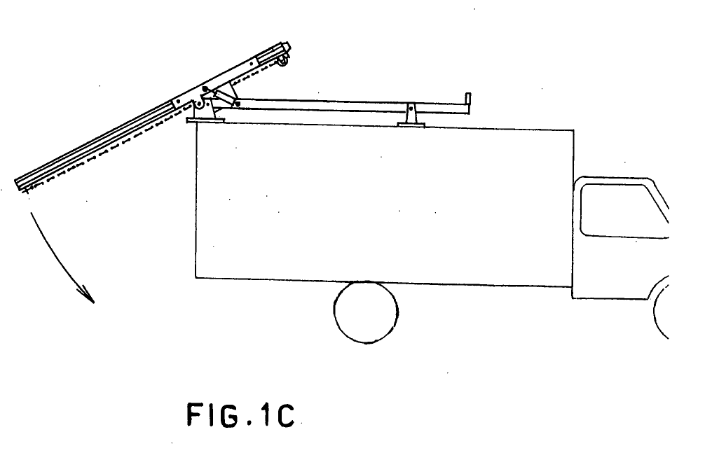

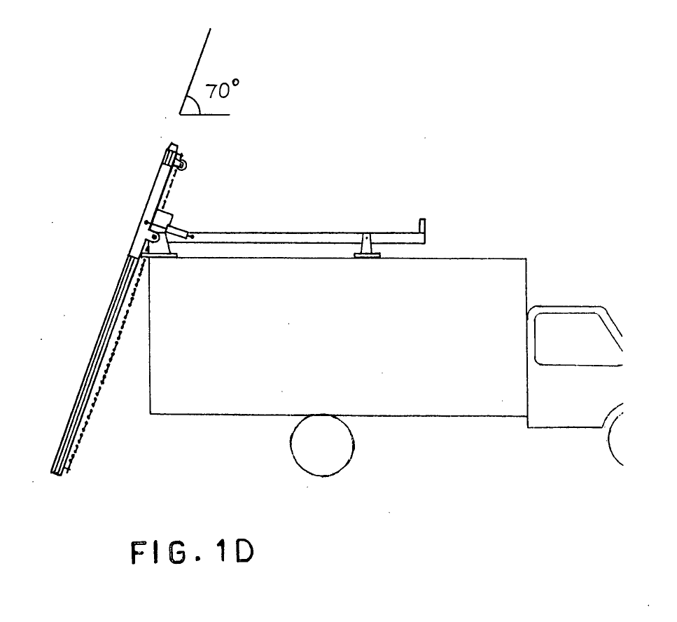

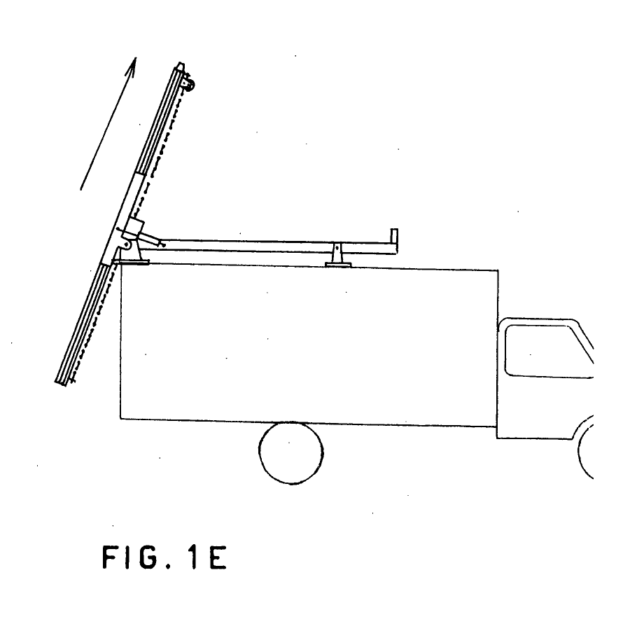

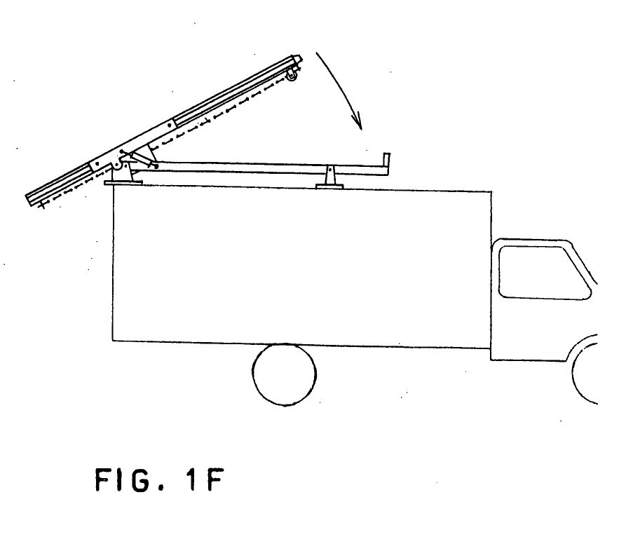

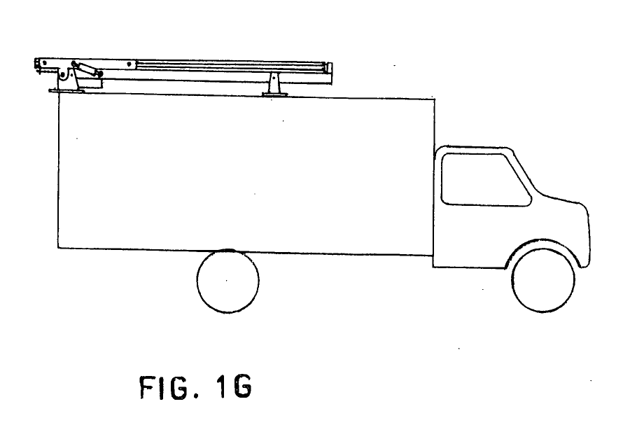

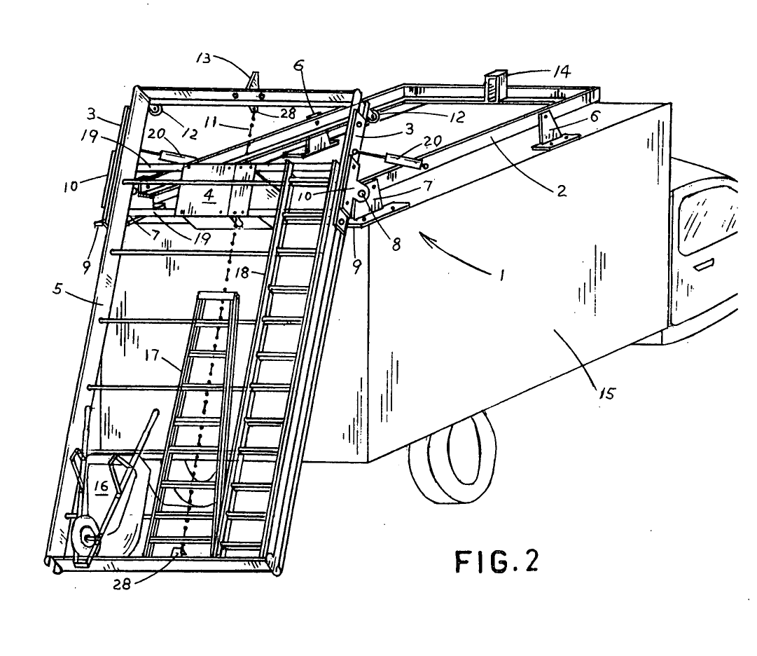

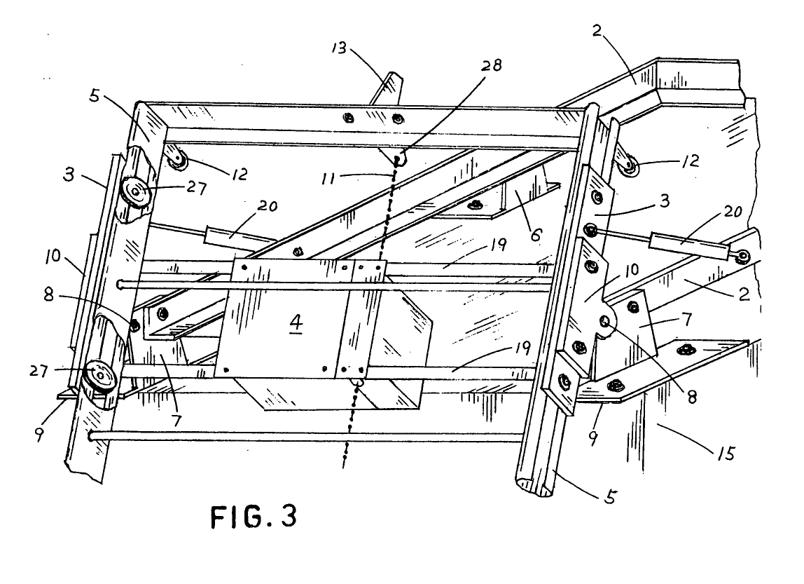

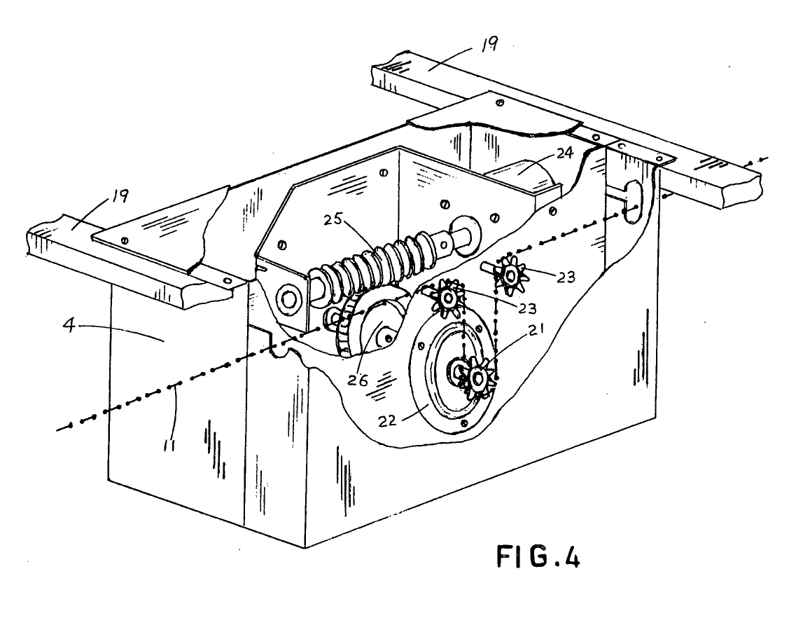

In order to gentle the pivotal movements of the sliding ladder rack 5 and the pivoting guide 3 shown in FIG. 1C and FIG. 1F a pair of bi-direction hydraulic damper 20 is provided which is coupled between the fixed guide 2 and the pivotal guide 3 near the pivot pins 8 as shown in FIG. 3.

FIG. 4 is shown an according to the present invention preferable disposition of motor 24; worm 25; worm gear 26; driving gear 21; bearing plate 22; guide gear 23 and chain 11 in driving box 4. The chain 11 is engaged with the driving gear 21 via the two guide gears 23. Each end of the chain 11 is connected to the chain connector 28 separately which is provided in the centre of the front end and the rear end of the sliding ladder rack 5 (see FIG. 2).

This invention has been described with reference to particular means and embodiments. Various changes and modifications can be made to carry out the invention. For example, said C-shape cross-section ladder rack 5 can be changed to rectangle cross-section bar sliding between the guide wheels which have grooved surface; said T-shape pivotal arm can be triangle; in a particular situation (a trailer is hooked behind the vehicle) the ladder rack system 1 can be mounted on the vehicle's roof transversally and the loading/unloading position is in the side of the vehicle. However, it is to be understood that various changes and modifications can be accomplished without departing described above.

What is claimed is:

1. A motor driven ladder rack for moving ladders and other equipments between the stowage position and the loading/unloading position, said ladder rack comprising:
a fixed guide assembly which is mounted on the roof of a vehicle;
a pivotal guide assembly that is pivotally coupled to the fixed guide assembly by two pivot pins so said pivotal guide can pivots respect with the fixed guide assembly;
a driving box is mounded underneath the pivotal guide assembly and in the said driving box the motor and gear system are located; and
a sliding ladder rack driven by motor for moving the ladders and other equipments between the stowage position and the loading/unloading position without physical power needed.

2. A ladder rack as in claim 1, wherein the fixed guide assembly provides a support and mounting structure for the pivotal guide assembly and the sliding ladder rack assembly, so said fixed guide assembly is a frame assembly as well.

3. A ladder rack as in claim 2, further comprising a pair front supporter and a pair rear supporter provided under the fixed guide, by said supporters the fixed guide is fixed on a vehicle's roof.

4. A ladder rack as in claim 1, wherein the pivotal guide assembly is pivotally coupled to the fixed guide assembly via pivot pin by which the pivotal guide assembly can pivots with respect to the fixed guide assembly freely.

5. A ladder rack as in claim 1, wherein the sliding ladder rack sliding coupled to the pivotal guide can slide on and pivot with the pivotal guide.

6. A ladder rack as in claim 1, wherein the motor and the gear system are located in the driving box which is fixed underneath the pivotal guide assembly.

7. A ladder rack as in claim 5, further comprising two chain connector provided on the centre of the front end and rear end of the sliding ladder rack assembly to said chain connector each end of the chain is connected separately.

8. A ladder rack as in claim 5, further comprising two rolling wheels provided on the both side of the front end of the sliding ladder rack, the sliding ladder rack can slide on the fixed guide with these two rolling wheels when the sliding ladder rack is in the horizontal position.

9. A ladder rack as in claim 4, further comprising two pairs of guide wheel pivotally coupled in both side of the pivotal guide, the sliding ladder rack is engaged with said guide wheels and on which slides with respect to the pivotal guide.

10. A ladder rack as in claim 1, further including a pair of bi-direction hydraulic damper to gentle the pivoting movement of the sliding ladder rack and the sliding pivotal guide.

11. A ladder rack as in claim 1, further including a wedge provided on the centre of the front end of the sliding ladder rack and a wedge holder provided on the front end of the fixed guide, said wedge is in the wedge holder when the sliding ladder rack is in the stowage position.

12. A ladder rack as in claim 1, therein in a particular situation, the ladder rack system can be mounted on the vehicle's roof transversally and the loading/unloading position is in the side of the vehicle.

13. A motor driven ladder rack mounted on a vehicle's roof for moving the ladders and other equipments between the stowage position and loading/unloading position at which the ladders and equipments can be loaded onto or unloaded from the rack, said ladder rack comprising:
a fixed guide assembly as well as a frame assembly including front pair supporter and rear pair supporter, by which said fixed guide assembly is mounted on said vehicle's roof;
a pivotal guide assembly pivotally coupled to the fixed guide assembly by pivot pin, said pivotal guide including two pairs of guide wheel;
a driving box in which the motor and gear system are located;
a sliding ladder rack linked with driving box by chain and sliding coupled to pivotal guide, said sliding ladder rack having two roll wheels on front end for sliding on the fixed guide, and said sliding ladder rack sliding on both the pivotal guide and the fixed guide when the ladder rack is in horizontal position, and the ladder rack sliding exclusively on the pivotal guide when the ladder rack departs from the horizontal position.

14. A ladder rack as in claim 13, further comprising a wedge provided on the centre of front end of the sliding ladder rack and a wedge holder provided on the centre of the front end of the fixed guide, in the stowage position said wedge is held in the wedge holder, so the sliding ladder rack being stable.

15. A ladder rack as in claim 13, further comprising a pair of bi-direction hydraulic damper coupling between the fixed guide and the pivotal guide, said pair of damper gentles the pivoting movement of the ladder rack and the pivotal guide.

16. A ladder rack as in claim 13, wherein the ladder rack driven by motor from the horizontal-stowage position sliding backward on the pivotal guide and the fixed guide at the same time, then under the acting force of gravity the ladder rack departing the horizontal position, pivoting downward with the pivotal guide together, sliding on the pivotal guide exclusively to the generally vertical position.

17. A ladder rack as in claim 13, wherein the ladder rack pulled up by motor from the generally vertical position, sliding upward on the pivotal guide exclusively, and under the acting force of gravity pivoting downward to the roof of the vehicle with the pivotal guide together then sliding forward on both the pivoting guide and fixed guide in the horizontal position.
